(19) United States
(12) Patent Application Publication
(10) Pub. No.: US 2022/0276062 A1
(43) Pub. Date: Sep. 1, 2022

(54) IMPROVED SYSTEM FOR PLANNING ROUTES FOR USERS OF A MULTIMODAL STRUCTURED TRANSPORT NETWORK

(71) Applicants: ALSTOM HOLDINGS, SAINT-OUEN-SUR-SEINE (FR); Institut de Recherche Technologique SystemX, PALAISEAU (FR)

(72) Inventors: Pascal POISSON, SCEAUX (FR); Manel ABID, PARIS (FR); Lionel SCREMIN, CALUIRE-ET-CUIRE (FR); Omar DIB, ANTONY (FR)

(21) Appl. No.: 17/631,105

(22) PCT Filed: Jul. 29, 2020
(86) PCT No.: PCT/EP2020/071388

§ 371 Date: Jan. 28, 2022

(30) Foreign Application Priority Data
Jul. 29, 2019 (FR) FR1908619

(51) Int. Cl. G01C 21/34; G01C 21/36

(52) U.S. Cl. CPC G01C 21/3423; G01C 21/3484; G01C 21/3605

(57) ABSTRACT

This system (50) for planning routes for users (5) of a multimodal structured transport network recommends an optimal route to a user to make a journey on a multimodal network between a departure station and a destination station. The system updates, in real time, an instantaneous graph representative of the multimodal network and current use of the multimodal network based on description information describing a current state of the traffic at the current instant and prediction information predicting the evolution of the state of the traffic from the current instant, the graph being initialized based on planning information associated with nominal use of the multimodal network, the planning system comprising a module (56) for determining an optimal route capable of using the instantaneous graph in order to provide an optimal route adapted to the current use of the multimodal network at the request of a user.

The invention relates to the field of systems for planning routes for users of a multimodal structured transport network, in particular for public transport.

Online services are known that allow a user to plan his journey in advance between a departure station and a destination station, in particular by selecting the times of various means of public transport allowing him to make a connection in an intermediate station with the shortest possible waiting time.

However, while such services make it possible to recommend an optimized route for nominal use of the network, they do not allow, or allow in a very limited manner, accounting for unexpected events that disrupt nominal use and risk invalidating the recommended optimal route.

The aim of the invention is therefore to resolve this problem, in particular by proposing a rerouting solution in case of traffic disruptions.

To do this, the invention relates to a system for planning routes for users of a multimodal structured transport network able to recommend an optimal route to a user to make a journey on said multimodal network between a departure station and a destination station, characterized in that it is able to update, in real time, an instantaneous graph representative of the multimodal network and current use of the multimodal network based on description information describing a current state of the traffic at the current instant and prediction information predicting the evolution of the state of the traffic from the current instant, the graph being initialized based on planning information associated with nominal use of the multimodal network, the planning system comprising a module for determining an optimal route capable of using the instantaneous graph in order to provide an optimal route adapted to the current use of the multimodal network at the request of a user.

According to specific embodiments, the system has one or more of the following features, considered alone or according to any technically possible combinations:
the system further comprises a graph initialization module able to generate an initial graph from the description of the multimodal network, timetables describing a nominal use of the network and a history of past states of the traffic on the multimodal network when nominal use was provided.
the past states taken into account by the graph initialization module are selected based on a plurality of context variables.
The system further comprises a graph updating module able to update the initial graph based on description information describing the state of the traffic and prediction information predicting the evolution of the state of the traffic, to obtain the instantaneous graph.

The invention also relates to an overall supervision system, characterized in that it incorporates a route planning system according to the previous system, the graph initialization module being interfaced on the one hand with a historical database and with an operational data management system and the graph updating module being interfaced with the operational data management system and a prediction system.

The invention also relates to a method for planning routes for users of a multimodal structured transport network making it possible to recommend an optimal route to a user to make a journey on said multimodal network between a departure station and a destination station, characterized in that the method consists in a step of updating, in real time, an instantaneous graph representative of the multimodal network and current use of the multimodal network based on description information describing a current state of the traffic at a current instant and prediction information predicting the evolution of the state of the traffic from the current instant, the instantaneous graph being determined based on an initial graph initialized based on planning information associated with nominal use of the multimodal network, and in a step for determining an optimal route in order to provide, at the request of the user, an optimal route adapted to the current use of the multimodal network from the instantaneous graph output from the updating step.

According to specific embodiments, the method comprises one or more of the following features, considered alone or according to any technically possible combinations:
a step for initializing a graph able to generate the initial graph from the description of the multimodal network, timetables describing a nominal use of the network and a history of past states of the traffic on the multimodal network when nominal use was provided.
the past states taken into account during the graph initialization step are selected based on a plurality of context variables.
the update step consists, to obtain the instantaneous graph, of updating the initial graph based on description information describing the current state of the traffic and prediction information predicting the evolution of the state of the traffic.
the step of initializing a graph uses information from a historical database and from an operational data management system as input, and the step of updating a graph uses information from the operational data management system and from a prediction system as input.

The invention also relates to an overall supervision system, characterized in that it incorporates a route planning system according to the previous system, the graph initialization module being interfaced on the one hand with a historical database and with an operational data management system and the graph updating module being interfaced with the operational data management system and a prediction system.

The invention and its advantages will be better understood upon reading the following detailed description of one particular embodiment, provided solely as a non-limiting example, this description being done in reference to the appended drawings, in which:

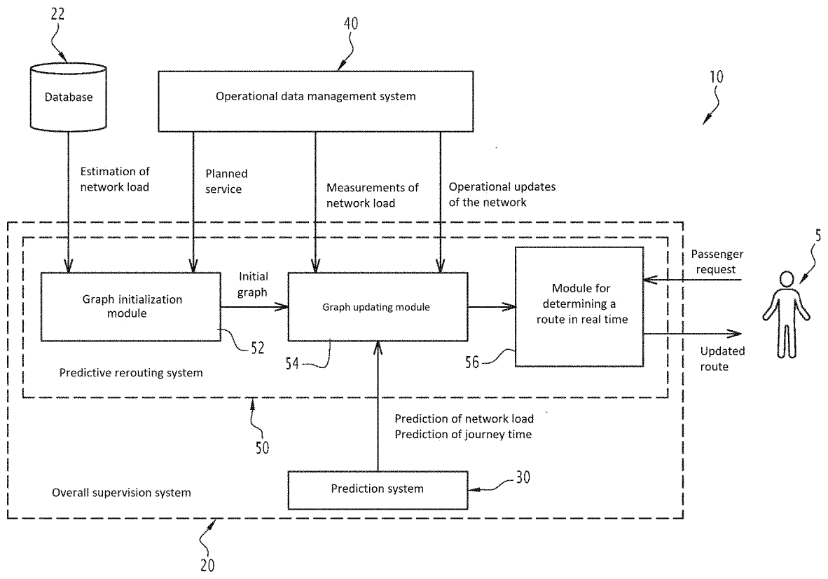

FIG. 1 is a schematic illustration, in block form, of an overall supervision system comprising a route planning system according to the invention;

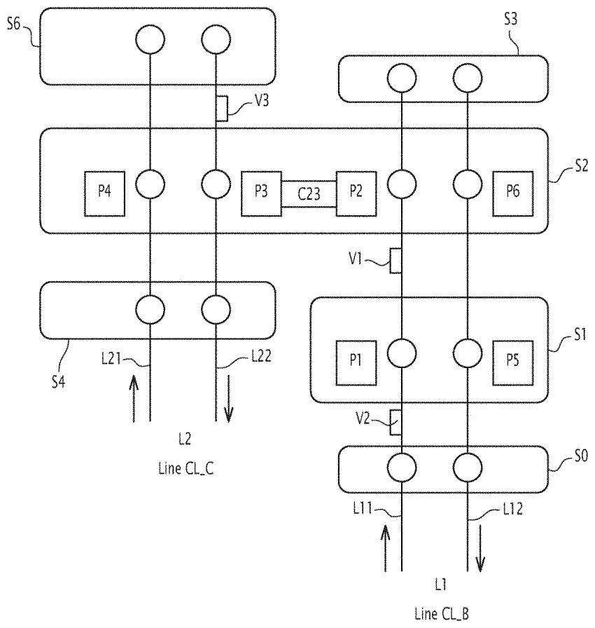

FIG. 2 is a schematic illustration of a portion of a public transport multimodal network, near a transit station between two lines served by public transport means, advantageously of different types,

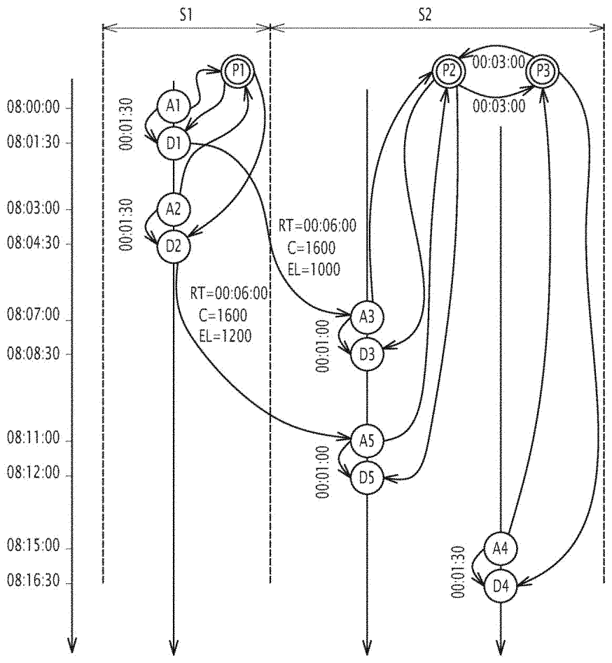

FIG. 3 is an initial graph calculated offline by the route planning system of FIG. 1 for the portion of the network shown in FIG. 2; and

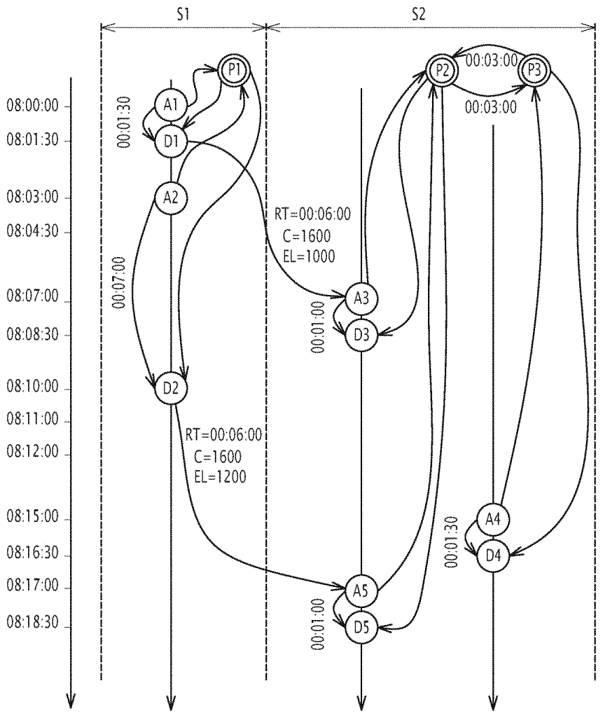

FIG. 4 is an instantaneous graph updated dynamically by the route planning system of FIG. 1 from the initial graph of FIG. 3.

The route planning system according to the invention advantageously belongs to an overall supervision system of a supervision infrastructure for a land-based multimodal transport network as described in patent application FR 3,047,835.

As shown in FIG. 1, the supervision infrastructure 10 comprises an overall supervision system 20 interfaced with a database 22 and an operational data management system 40.

The database 22 stores a history of the state of the traffic on the multimodal network.

The operational data management system 40 is able to determine an instantaneous state of the traffic on the multimodal network.

The instantaneous state of the traffic is for example characterized by a plurality of variables, in particular variables associated with a load level (in terms of number of passengers) of the entities of the network that are the vehicles and the platforms.

Advantageously, the instantaneous states delivered by the system 40 are stored progressively in the database 22.

The overall supervision system 20 comprises a prediction system 30 and a route planning system 50.

The route planning system 50 comprises a module 52 for computing an initial graph, a module 54 for updating the initial graph to obtain an instantaneous graph, and a module 56 for determining routes in real time.

The module 56 for determining routes in real time comprises an interface allowing a user 5 to interact with the system 50 for example using a computer terminal, connected to a communication network, such as the Internet. The user 5 is thus able to send the module 56 a query, indicating the value of a plurality of parameters, in particular his station of origin, his arrival station and his preferences (journey time, number of connections, etc.), and to receive a response from the module 56 indicating an optimal recommended route at the query instant.

The module 52 is interfaced with the database 22 and the operational data management system 40 so as to compute, from the topology of the multimodal network and the current and past states of the traffic on this network, an initial graph representative of the state of the traffic on the multimodal network according to nominal use.

The module 54 is interfaced with the operational data management system 40 and the prediction system 30. The module 54 is able to generate an instantaneous graph resulting from the updating of the initial graph from the current operational situation, as measured by the system 40, or from the future operational situation, as anticipated by the system 30.

The module 56 bases itself on the instantaneous graph output by the module 54 to determine the optimal route to recommend to the user 5.

An example of the general operation of the system according to the invention will now be presented in reference to FIGS. 2, 3 and 4.

FIG. 2 shows a portion of the multimodal network 2 equipped with the infrastructure 10 of FIG. 1.

This figure shows a first line L1 made up of an outbound path L11 and a return path L12 traveling parallel to one another.

The vehicles traveling along the line L1 stop at the stations S0, S1, S2 and S3. The stations S1 and S2 comprise platforms that allow the exchange of passengers when a vehicle is stopped along them. Thus, the station S1 comprises a platform P1 along the outbound path L11 and a platform P5 along the return path L12. Thus, the station S2 comprises a platform P2 along the outbound path L11 and a platform P6 along the return path L12.

A second line L2 is also shown made up of an outbound path L21 and a return path L22 traveling parallel to one another.

The vehicles traveling along the line L2 stop at the stations S4, S2 and S6. The station S2 comprises platforms that allow the exchange of passengers. Thus, the station S2 comprises a platform P4 along the outbound path L21 and a platform P3 along the return path L22.

The station S2 is a transit station between the lines L1 and L2. It allows a user arriving at the station S2 by the first line L1 to leave again on the second line L2, and conversely to arrive on the second line L2 and to leave again from the station S2 on the first line L1.

For example, the exchange of passengers is possible between the platforms P2 and P3, the passengers using a corridor C23.

In FIG. 2, a first vehicle V1 travels on the outbound path L11 of the first line L1, a second vehicle V2 travels on the outbound path L11, behind the first vehicle V1, and a third vehicle V3 travels on the return path L22 of the second line L2.

The system 50 allows a user 5 whose initial route provided a connection at the station S2 between the second vehicle V2 and the third vehicle V3 to be rerouted in real time to another route to account for the current state of the traffic, in the case at hand a delay of the second vehicle V2.

To do this, the system 50 uses a graph that is a specific representation of the state of the traffic on the multimodal network 2.

FIG. 3 shows an initial graph. This graph is generated by the module 52 from a description of the multimodal network, planning information of the traffic for nominal use of the network and historical information of the state of the traffic when such nominal use was provided. In particular, the system 40 communicates travel timetables of the vehicles on the different lines of the multimodal network for nominal use of each of the lines. “Nominal” means use of the network without incident, and in particular during which theoretical arrival and departure times at the station of the vehicles traveling on the network are respected.

In FIG. 3, the initial graph is limited, for the station S1, to the platform P1, and for the station S2, to the platforms P2 and P3. These platforms are considered to be “physical” nodes.

The two oriented links connecting the platforms P2 and P3 indicate the possibility of an exchange of passengers between these two platforms at the station S2, one indicating the movement of passengers from the platform P2 toward the platform P3, the other indicating the movement of passengers from the platform P3 toward the platform P2.

Each of these links is associated with at least one travel time attribute, for example equal to 3 min, indicating the time necessary for a passenger to go from one to another of the platforms by using the corridor C23.

The initial graph also comprises pairs of “event” nodes. They are represented by a circle in FIG. 3, arranged along a time axis, each time axis being associated with a platform.

A pair of “event” nodes comprises a node A, corresponding to the “arrival” event of a vehicle along the associated platform, and a node D, corresponding to the “departure” event of this same vehicle from this same platform.

A link oriented from node A toward node D of the same pair of “event” nodes indicates stopping of the vehicle along the associated platform. This link is characterized by an attribute of stopping time at station.

Thus, the pair of nodes A1 and D1 represents the arrival and departure of the first vehicle V1 along the platform P1. The nominal stop time of the vehicle V1 at the station S1 is 1:30 minutes.

Thus, the pair of nodes A2 and D2 represents the arrival and departure of the second vehicle V2 along the platform P1. The nominal stop time of the vehicle V2 at the station S1 is 1:30 minutes.

Thus, the pair of nodes A3 and D3 represents the arrival and departure of the first vehicle V1 along the platform P2. The nominal stop time of the vehicle V1 at the station S2 is 1:00 minutes.

Thus, the pair of nodes A5 and D5 represents the arrival and departure of the second vehicle V2 along the platform P2. The nominal stop time of the vehicle V2 at the station S2 is 1:00 minutes.

Thus, the pair of nodes A4 and D4 represents the arrival and departure of the third vehicle V3 along the platform P3. The nominal stop time of the vehicle V3 at the station S2 is 1:30 minutes.

An oriented link connects, for the same vehicle, a departure node D associated with the platform and an arrival node A associated with the following platform along the same line in the direction of movement of the vehicle.

Thus, a link connects the departure node D1, associated with the platform P1, to the arrival node A3, associated with the platform P2. It corresponds to the travel of the first vehicle V1 from the platform P1 to the platform P2 according to the timetable.

Likewise, a link connects the departure node D2, associated with the platform P1, with the arrival node A5, associated with the platform P2. It corresponds to the travel of the second vehicle V2 from the platform P1 to the platform P2.

Such a link is characterized by attributes of travel time between stations, maximum load authorized on board the considered vehicle, and average load of the vehicle (obtained by using historical traffic data).

An arrival node A is connected to the associated platform P to indicate the possible transfer of passengers from the vehicle to the platform. Each link is associated with an attribute of average number of passengers leaving the vehicle (obtained by using historical traffic data).

Reciprocally, each departure node D is connected to the associated platform to indicate the possible transfer of passengers from the platform to the vehicle stopped along this platform. Each link is associated with at least one attribute of average number of passengers boarding the vehicle (obtained by using historical traffic data).

FIG. 4 shows an instantaneous graph resulting from updating the initial graph of FIG. 3.

The instantaneous graph is similar to the initial graph of FIG. 3. However, the departure node D2 has been moved along the time axis of the platform P1 to account for a prolonged stop of the second vehicle V2 at the first station S1. In fact, the stop time indicated between the arrival and departure nodes, A2 and D2, is now, in this example, estimated at a duration of 7:00 min in light of the typology of the incident.

Thus, the departure instant D2 of the second vehicle V2 from the platform P1 is delayed.

As a result, the pair of nodes A5, D5 associated with the following platform P2 is also offset in time to anticipate the fact that the second vehicle V2 is not expected at the station S2 before 8:17:00, the estimated travel time between the platform P1 and the platform P2 here being kept at 6:30 min. For this journey, the estimated loads are reevaluated.

It should be noted that the arrival node A5 is now placed temporally after the departure node D4, indicating that the second vehicle V2 will in all likelihood arrive at the station S2 after the third vehicle V3 has left.

Thus, a user 5 whose initial route, developed from the initial graph of FIG. 3, provided for a connection at the intermediate station S2 by going from the second vehicle V2 to the third vehicle V3, is now void. A new route must be developed from the instantaneous graph of FIG. 4 and offered to the user 5.

To do this, the module for determining a route 56 uses the instantaneous graph to verify whether the initial route is still achievable in light of the event that has disrupted traffic, in the case at hand the stopping of the second vehicle V2 at the station S1, or whether the user 5 should be rerouted to optimize his journey or the portion of his journey that remains.

The structure of the route planning system 50 will now be described in more detail. The module 52 is able to communicate with the system 40. It sends a request to the system 40, which responds by returning planning information, such as the various timetables. The timetables for each line of the multimodal network indicate the various vehicles traveling throughout the day and, for each vehicle, the arrival and departure times for each station on the line.

The module 52 also receives, from the database 22, a history of the state of the traffic for nominal use of the network. The database 22 stores historical data for the traffic on the network, and in particular a history of the load of the platforms and the vehicles for different operating contexts.

“Operating context” refers to a set of context variables describing the envisaged nominal use for the traffic on the network and used to initialize the graph. This for example involves a type of day (weekday or weekend), a time slot (peak time, off-peak time) or specific circumstances provided during the usage day (sporting event at a particular station, for example). In particular, the estimated load of the number of passengers may be weighted or recalculated based on the context variables.

This historical information is loaded by the module 52 and used to instantiate the initial graph associated with the multimodal network, like that of FIG. 3.

During the use of the network, the system 40 collects instantaneous measurement data for the traffic from various sources (computers integrated into the vehicles, ground sensors, supervision system supervising the travel of the vehicles along each line of the network, etc.). The module 40 analyzes these measurements and merges them to obtain high-level data indicative of the instantaneous state of the traffic. These data for example comprise:
A measurement of the instantaneous load on the platforms and the vehicles in circulation;
The current missions of the vehicles in circulation, these missions accounting for any modifications relative to a nominal mission (for example, no longer stopping at a station);
The estimated arrival instants at the next station. This estimate is for example obtained from a supervision system.

The module 54 subscribes to a distribution service for data from the system 40 so as to periodically receive the instantaneous state of the traffic.

The prediction system 30 serves to deliver predictive data on the evolution of the traffic, in particular an estimate of the load at each platform of the multimodal network, and an estimate of the journey times of the vehicles.

The prediction system 30 is advantageously executed when certain critical events appear on the multimodal network, such as for example the occurrence of an incident or the detection of an overload of passengers at a point of the network.

The module 54 subscribes to a distribution service for data from the prediction module 30.

The taking into account of these estimated data by the module 54 makes it possible to take account of the likely evolution of the state of the network in the near future and not only in its current state.

Taking this likely evolution into account makes it possible increase the robustness of the recommendation that will be made to the user. This implies that the system 50 is able to account for error intervals around the parameters that it takes into account in order to generate the graphs and determine the optimal route.

During the use of the multimodal network, the module 54 updates the graph initialized by the module 52 based on deviations observed with respect to the planned nominal use.

To do this, the module 54 more particularly uses the following information:
Cancellation or modification of a vehicle's mission;
Estimated arrival time of a vehicle along a specific platform, advantageously when this estimated arrival time is greater than the planned arrival time by a predetermined deviation;
The actual departure times of a vehicle from a platform, advantageously when this actual departure time deviates from the planned departure time by a deviation greater than a predetermined deviation;
The detection of congestion points on the network, such as for example the observation or the estimation of a passenger load on a platform that deviates beyond a predetermined critical threshold, for example determined from the history stored in the database 22.

Each user 5 subscribed to the rerouting service offered by the system 50 indicates, in a query request for the system 50, query parameters such as his station of origin, his destination station, certain preferences relative to the route (time, length, preferred mode of public transportation, etc.). Optionally, this request may be developed automatically or semiautomatically from information related to a user profile and/or past requests by the user. In response, the system 50 supplies the user 5 with an optimal route. This route may be transmitted automatically and periodically to the user during his travel. This optimal route may constitute a variant of the journey initially proposed so as to account for events that have occurred in the use of the network.

In a variant, the optimal route is provided to the user 5 only when the latter applies his request to the system 50.

The module 56 bases itself on the instantaneous graph and not on the initial graph to make a recommendation adapted to a request to be processed. The module 56 implements a search algorithm for the shortest path along the instantaneous graph. This shortest path accounts for weights over the links connecting the nodes. The weight of a link is calculated based on all of the attributes of this link or part of these attributes.

The person skilled in the art will note that the module 56 is based on a statistical approach allowing robust optimization of a route. According to this approach, the parameters of interest in optimizing the route are random variables having a certain probability distribution, and the route ultimately proposed to the user is the likeliest route. The module 56 is also based on a particular graph making it possible simply to describe the multimodal network and the traffic on the network. It thus represents certain static aspects of the network, such as the various lines and the possibility for switching from one line to another. This graph represents certain dynamic aspects of the multimodal network, such as the available capacity of the various vehicles of the various modes of transportation.

The person skilled in the art will understand that the system 50 that has been described above allows the implementation of a route planning method, in particular offering a functionality for real-time rerouting of users of a multimodal network.

1. A planning system for planning routes for users of a multimodal transport network, the planning system being able to recommend an optimal route to a user to make a journey on said multimodal transport network between a departure station and a destination station, wherein the planning system is able to update, in real time, an instantaneous graph that represents the multimodal transport network and a current use of the multimodal transport network, based on description information describing a state of a traffic at a current instant and prediction information predicting an evolution of the state of the traffic from the current instant, the instantaneous graph being determined based on an initial graph initialized based on planning information associated with a nominal use of the multimodal transport network, the planning system comprising a module for determining the optimal route based on the instantaneous graph in order to provide the optimal route adapted to the current use of the multimodal transport network on request of the user.

2. The planning system according to claim 1, further comprising a graph initialization module for generating the initial graph from a description of the multimodal transport network, timetables describing the nominal use of the multimodal transport network and a history of past states of the traffic on the multimodal transport network when the nominal use was provided.

3. The planning system according to claim 2, wherein the past states taken into account by the graph initialization module are selected based on a plurality of context variables.

4. The system according to claim 2, further comprising a graph updating module for updating the initial graph based on the description information describing the state of the traffic at the current instant and the prediction information predicting the evolution of the state of the traffic from the current instant, to obtain the instantaneous graph.

5. An overall supervision system incorporating a planning system according to claim 4, the graph initialization module being interfaced hand with a historical database and with an operational data management system and the graph updating module being interfaced with the operational data management system and a prediction system.

6. A method for planning routes for users of a multimodal transport network making it possible to recommend an optimal route to a user to make a journey on the multimodal transport network between a departure station and a destination station, wherein the method comprises:
a step of updating, in real time, an instantaneous graph that represents the multimodal transport network and a current use of the multimodal transport network based on description information describing a state of a traffic at a current instant and prediction information predicting an evolution of the state of the traffic from the current instant, the instantaneous graph being determined based on an initial graph initialized based on planning information associated with a nominal use of the multimodal transport network, and
a step of determining the optimal route in order to provide, on request of the user, the optimal route adapted to the current use of the multimodal transport network from the instantaneous graph output from the step of updating.

7. The method according to claim 6, further comprising a step of graph initializing to generate the initial graph from a description of the multimodal transport network, timetables describing the nominal use of the multimodal transport network and a history of past states of the traffic on the multimodal transport network when the nominal use was provided.

8. The method according to claim 7, wherein the past states taken into account during the step for of graph initializing are selected based on a plurality of context variables.

9. The method according to claim 7, wherein the step of updating consists, in order to obtain the instantaneous graph, of updating the initial graph based on the description information describing the state of the traffic at the current instant and the prediction information predicting the evolution of the state of the traffic.

10. The method according to claim 7, wherein the step of graph initializing uses information from a historical database and from an operational data management system as input, and the step of updating the instantaneous graph uses information from the operational data management system and from a prediction system as input.
